(19) United States
(12) Patent Application Publication
(10) Pub. No.: US 2022/0124501 A1
(43) Pub. Date: Apr. 21, 2022

(54) METHOD AND APPARATUS FOR PROTECTING PDU SESSIONS IN 5G CORE NETWORKS

(71) Applicant: Nokia Solutions and Networks Oy, Espoo (FI)

(72) Inventors: Nagendra S BYKAMPADI, Bangalore (IN); Silke HOLTMANNS, Klaukkala (FI); Bruno LANDAIS, Pleumeur-Bodou (FR)

(21) Appl. No.: 17/422,707

(22) PCT Filed: Jan. 15, 2020
(86) PCT No.: PCT/EP2020/050903

§ 371 Date: Jul. 13, 2021

(30) Foreign Application Priority Data
Jan. 18, 2019 (IN) 201941002275

(51) Int. Cl. H04W 12/088; H04W 76/30

(52) U.S. Cl. CPC H04W 12/088; H04L 63/0236; H04W 76/30

(57) ABSTRACT

A user plane network entity of a 5G core network performs: obtaining GPRS Tunneling Protocol User Plane (GTP-U) tunneling information of a new or updated protocol data unit (PDU) session from a control plane network entity of the 5G core network; and adjusting according to the obtained GTP-U tunneling information a GTP-U firewall for selectively allowing to pass through only GTP-U traffic concerning GTP-U tunnels defined by the GTP-U tunneling information. The control plane network entity performs: obtaining from control plane signaling the GTP-U tunneling information and communicating same to the GTP-U firewall. A system containing the user plane network entity and the control plane network entity is also disclosed.

### TECHNICAL FIELD

Various example embodiments relate to protecting PDU sessions in 5G core networks. In particular, though not exclusively, some example embodiments relate to protecting 5G core networks from spurious or malicious user plane traffic.

### BACKGROUND

This section illustrates useful background information without admission of any technique described herein representative of the state of the art.

5G core networks provide services and functions, which results in all new level of signaling between various network elements and all new security challenges. Even traffic between different Public Land Mobile Networks, PLMNs, may traverse various intermediate IP networks or IPXs such that the user plane traffic of Protocol Data Unit, PDU, sessions and their control are exposed to potentially malicious parties. In particular, there is a risk that user plane traffic is taking place without a PDU session established through control plane signaling, that may lead to fraud, free data usage and malicious data entering the 5G core network.

### SUMMARY

Various aspects of examples are set out in the claims.

According to a first example aspect, there is provided a method in a user plane network entity of a 5G core network, comprising:

obtaining GPRS Tunneling Protocol User Plane, GTP-U, tunneling information of a new or updated protocol data unit, PDU, session from a control plane network entity of the 5G core network; and

adjusting according to the obtained GTP-U tunneling information a GTP-U firewall for selectively allowing to pass through only GTP-U traffic concerning GTP-U tunnels defined by the GTP-U tunneling information.

The GTP-U tunneling information may be obtained by receiving the GTP-U tunneling information as pushed by the control plane network entity.

The method may further comprise receiving from the control plane network element GTP-U tunneling information of a PDU session that is released; and

selectively causing the GTP-U firewall to disallow to pass through the GTP-U traffic concerning the GTP-U tunnel that is no longer needed for the released PDU session.

The user plane network entity may be a Security Edge Protection Proxy, SEPP, for user plane traffic, SEPP-U.

The user plane network entity may comprise the GTP-U firewall.

The user plane network entity may monitor GTP-U traffic incoming to a 5G core network. The user plane network entity may be configured to monitor GTP-U traffic on an N9 interface.

The user plane network entity may be collocated with a 5G user plane function, UPF

The GTP-U firewall may inspect incoming GTP-U traffic by checking that a destination IP address and tunnel endpoint ID, TEID, in received GTP-U packets belongs to any one of active PDU sessions and to drop the GTP-U packets not belonging to the active PDU sessions.

The GTP-U firewall may inspect incoming GTP-U data packets by checking a source address of an outer IP header and dropping or rejecting the GTP-U data packets unless the source IP Address in the outer IP header belongs to a valid PDU session.

The GTP-U firewall may inspect incoming GTP-U data packets by checking a tunnel endpoint ID, TEID, and dropping or rejecting the GTP-U data packets unless the TEID matches the TEID found of an active GTP-U tunnel.

The GTP-U firewall may inspect incoming GTP-U data packets by checking the source address, the destination IP address and the TEID.

According to a second example aspect, there is provided a method in a control plane network entity of a 5G core network, comprising:

obtaining from control plane signaling GPRS Tunneling Protocol User Plane, GTP-U, tunneling information of a new or updated protocol data unit, PDU, session; and

communicating the GTP-U tunneling information to a GTP-U firewall for selectively allowing to pass through only GTP-U traffic concerning GTP-U tunnels defined by tunneling information.

The method may further comprise detecting that the PDU session is released; and

communicating a respective change in the GTP-U tunneling information to a GTP-U firewall for selectively disallowing to pass through the GTP-U traffic concerning the GTP-U tunnel that is no longer needed for the released PDU session.

The control plane network entity may be a Session Management Function, SMF. Alternatively, the control plane network entity may be collocated with the SMF. The control plane network entity may be configured to communicate with the user plane network entity over an N4 interface.

The control plane network entity may be a Security Edge Protection Proxy, SEPP. The control plane network entity may be configured to detect the GTP-U tunneling information by intercepting passing-through PDU session establishment, modification and release messaging. The PDU session establishment, modification and release messaging may include an inter-PLMN HTTP message, such as an HTTP PUT, GET, POST, DELETE or PATCH message. The inter-PLMN HTTP post message may flow between respective session management functions of a home PLMN and of a visited PLMN.

The SEPP-U may be configured to operate as an intercepting or transparent proxy, where UPFs in the 5G core network do not need to be configured with information to route the user plane traffic through the SEPP-U. Alternatively, the SEPP-U may be configured to operate as a non-transparent proxy, where UPFs in the 5G core network are configured to transmit GTP-U packets to SEPP-U. The SEPP-U may have a secure interface with the UPFs.

In an example embodiment, the user plane network entity is a distributed entity comprising a plurality of units. The user plane network entity may comprise a pool of SEPP-Us that may be configured to access the tunneling information stored in a storage shared jointly accessible by the pool of the SEPP-Us.

According to a third example aspect, there is provided a user plane network entity of a 5G core network, comprising:

at least one memory function configured to store computer executable program code;

at least one processing function configured to execute the program code and to cause the user plane network entity to perform, on executing the program code:

obtaining GPRS Tunneling Protocol User Plane, GTP-U, tunneling information of a new or updated protocol data unit, PDU, session from a control plane network entity of the 5G core network; and

adjusting according to the obtained GTP-U tunneling information a GTP-U firewall for selectively allowing to pass through only GTP-U traffic concerning GTP-U tunnels defined by the GTP-U tunneling information.

The user plane network entity may be further configured to perform the method of any embodiments of the first example aspect.

According to a fourth example aspect, there is provided a control plane network entity of a 5G core network, comprising:

at least one memory function configured to store computer executable program code;

at least one processing function configured to execute the program code and to cause the control plane network entity to perform, on executing the program code:

obtaining from control plane signaling GPRS Tunneling Protocol User Plane, GTP-U, tunneling information of a new or updated protocol data unit, PDU, session;

and

communicating the GTP-U tunneling information to a GTP-U firewall for selectively allowing to pass through only GTP-U traffic concerning GTP-U tunnels defined by tunneling information.

The memory function may be or comprises a dedicated apparatus, such as a memory bank; memory pool or a memory circuitry. Alternatively, a function may established for this purpose using, for example, a suitable virtualization platform or cloud computing.

The processing function may be or comprises a dedicated apparatus, such one or more processors, processing circuitries or application specific circuitries. Alternatively, a function may be established for this purpose using, for example, a suitable virtualization platform or cloud computing.

According to a fifth example aspect, there is provided a system comprising the user plane network entity of the third example aspect and the control plane network entity of the fourth example aspect.

According to a sixth example aspect, there is provided a computer program comprising computer executable program code configured to execute any preceding method.

The computer program may be stored in a computer readable memory medium.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments have been illustrated in the foregoing. The embodiments in the foregoing are used merely to explain selected aspects or steps that may be utilized in implementations. Some embodiments may be presented only with reference to certain example aspects. It should be appreciated that corresponding embodiments may apply to other example aspects as well.

### BRIEF DESCRIPTION OF THE DRAWINGS

For a more complete understanding of example embodiments, reference is now made to the following descriptions taken in connection with the accompanying drawings in which:

FIG. 1 shows an architectural drawing of a system of an example embodiment, representing the 5G Core Network architecture;

FIG. 2 shows a block diagram of some elements of an example embodiment;

FIG. 3 shows a call flow that depicts PDU session establishment in Home-routed roaming scenario;

FIG. 4 shows a call flow that depicts PDU session creation request by an NF Service Consumer;

FIG. 5 shows a scenario where the Update service operation is used by a SMF in a visited PLMN to modify the PDU session;

FIG. 6 shows an example of the GTP-U TunnelInfo definition;

FIG. 7 illustrates signaling on the new interface between the SEPP-U and the control plane entity, where the control plane entity in this figure is an SMF;

FIG. 8 shows a flow chart of a method in a user plane network entity of a 5G core network;

FIG. 9 shows a flow chart of a method in a control plane network entity of a 5G core network; and

FIG. 10 shows a simplified block diagram of an apparatus 1000 according to an embodiment for implementing various network functions.

### DETAILED DESCRIPTION OF THE DRAWINGS

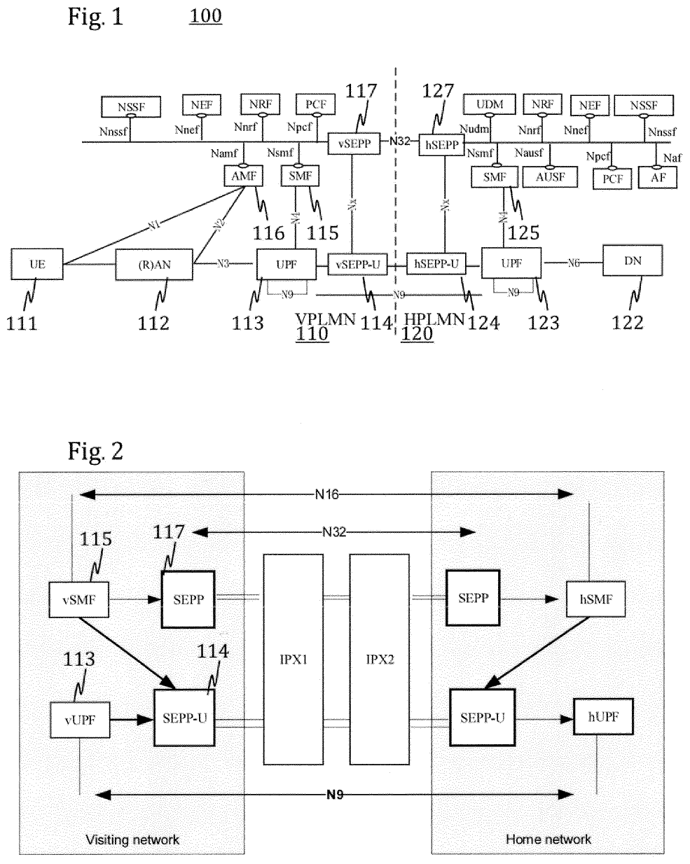

An example embodiment and its potential advantages are understood by referring to FIGS. 1 through 10 of the drawings. In this document, like reference signs denote like parts or steps.

FIG. 1 shows an architectural drawing of a system of an example embodiment. In FIG. 1, a visited public land mobile network, VPLMN 110 is schematically outlined on a left-hand side and a home PLMN or HPLMN 120 on the right-hand side. FIG. 1 is further divisible between control plane elements drawn above and user plane elements drawn below. Interfaces N1, N2, N4, Nx (new interface that is proposed to be defined) are drawn between the user plane and control plane functions.

The two PLMNs communicate on user plane over respective Security Edge Protection Proxy, SEPP, for user plane traffic, SEPP-U (new entity that is proposed to be defined), which are here denoted by their role as vSEPP-U 114 and hSEPP-U 124. In this context, the home PLMN is that to which a given subscriber has subscribed so both PLMNs are for some subscribers a home PLMN and for some other a visited PLMN. Similarly to the SEPP-U's 114, 124, also other elements drawn in FIG. 1 can be, designated as home or visited elements with a prefix h or v without necessary there being any difference in structure of the elements between the two PLMN's 100. In sake of simplicity, reference is yet made to these different roles by different reference signs for ease of referencing.

While the user plane traffic between the two PLMNs may pass through the respective SEPP-U's (that is proposed to be defined), the control plane traffic is exchanged by these PLMN's over respective vSEPP 114 and hSEPP 124. On top of FIG. 1, some control plane functions are drawn including an Access and Mobility Management function, AMF, 116 of the VPLMN 110, a Session Management Function, SMF 115 and a vSEPP 117. On the HPLMN 120 side, there are drawn a hSEPP 127 and SMF 125 of the HPLMN 120.

In FIGS. 1 and 2, the SEPP-U is an N9 firewall used for filtering GTP-U traffic at the edge of the PLMN. It has the following duties:

a) The SEPP-U checks destination address and GTP-U header of incoming GTP-U traffic against existing GTP-U sessions and decides whether to allow or not passing of the GTP-U traffic towards the 5G core network. The SEPP-U accepts incoming traffic from known peer networks to which a roaming agreement exists.

b) The SEPP-U validates with the SEPP (control plane) that the GTP-U packet pertains to an established PDU session (this is described in more detail in the following).

c) Filtering suspicious traffic at the entrance of the network.

Some embodiments use a new interface between SEPP-U and a Core Network control plane entity. The Core Network control plane entity is the one that supplies SEPP-U with the relevant information on GTP-U tunnels that's required for SEPP-U to perform its duties mentioned above. This new interface and its messages are used for communication between the core network control plane entity, such as SEPP or SMF, and the SEPP-U to establish the authenticity of a GTP-U session.

In FIG. 1, the SEPP is a Core Network control plane entity of interest and that has a new interface with the SEPP-U 114.

FIG. 2 shows a block diagram of some elements of an example embodiment. In FIG. 2 embodiment, it is the SMF 115 instead that is the control plane network entity of interest that has the new interface with the SEPP-U 114.

In the architecture of FIG. 1, GPRS Tunneling Protocol-GTP tunnels (GTP-U) using the GTPv1 protocol are established between the vUPF 113 and the hUPF 123 for carrying traffic of PDU sessions between the VPLMN 110 and the HPLMN 120. The GTP layer for the user plane, GTP-U, provides services for carrying user data packets between the networks. Packets from or to the devices or external data are encapsulated in a GTP-U Packet Data Unit, PDU. In an embodiment, this GTP-U PDU consists of a GTP-U header and a T-PDU. A T-PDU corresponds to a user data packet, e.g. an IP datagram, an Ethernet frame or unstructured PDU data, and is basically the payload that is tunneled in the GTP-U tunnel. In an embodiment, the GTP-U tunnel is created during the PDU session establishment.

In an embodiment, each GTP-U tunnel is identified by two unidirectional Tunnel End Point Identifiers called TEIDs and User Datagram Protocol, UDP/IP addresses, i.e. one UDP/IP address and TEID for traffic from vUPF 113 towards the hUPF 123 (uplink traffic) and one UDP/IP address and TEID for traffic from the hUPF 123 towards the vUPF (downlink traffic). These UDP/IP addresses and TEIDs are uniquely assigned per GTP-U tunnel, and therefore indirectly per PDU session and per user equipment (UE) (since one GTP-U tunnel is established over the N9 interface per PDU session of a UE).

In an embodiment, when a GTP-U tunnel is established on the 5G N9 interface between vUPF 113 and the hUPF 123, the vSMF 115 and vUPF 113 assign an IP address and TEID for GTP traffic coming from the hUPF 123, the hSMF 125 and hUPF 123 assign an IP address and TEID for GTP traffic coming from vUPF 113, and the vSMF 115 and the hSMF 125 exchange these IP addresses and TEIDs using HTTP signaling over N16 interface.

In an embodiment, the SEPP-U can determine an authorized control session (i.e. a PDU session established via N32) for the GTP-U traffic by co-operating with the control plane network element.

GTP-U Tunnels over the N9 interface are established between the 113 vUPF and the hUPF 123 in the following scenarios:

a) PDU Session Establishment

b) PDU Session Modification

c) EPS to 5GS idle mode or connected mode mobility.

GTP-U tunnels over the N9 interface are released between the vUPF 113 and the hUPF 123 in the following scenarios:

d) PDU Session Release

e) 5GS to EPS idle mode or connected mode mobility.

Let us next describe these scenarios in more detail.

a) PDU Session Establishment

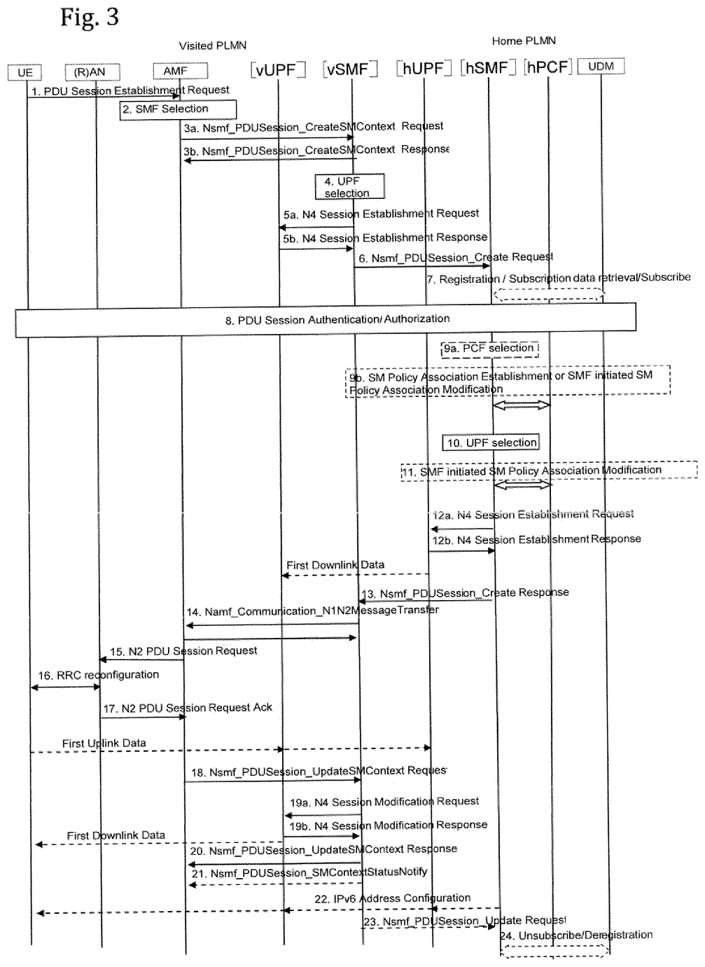

FIG. 3 shows a call flow that depicts PDU session establishment in Home-routed roaming scenario.

In step 6 of FIG. 3, the vSMF 115 issues a PDUSession Create Request including an information element, IE V-CN-Tunnel-Info. This PDUSession_Create Request contains a SUPI, GPSI (if available), DNN, S-NSSAI with the value defined by the HPLMN, PDU Session ID, V-SMF ID, V-CN-Tunnel-Info, PDU Session Type, PCO, Number Of Packet Filters, User location information, Access Type, PCF ID, SM PDU DN Request Container, DNN Selection Mode, [Always-on PDU Session Requested]). These abbreviations have the meanings known from the 5G. Protocol Configuration Options may contain information that hSMF may needs to properly establish the PDU Session (e.g. SSC mode or SM PDU DN Request Container to be used to authenticate the UE by the DN-AAA). The hSMF 125 may use DNN Selection Mode when deciding whether to accept or reject the UE request. If the vSMF 115 does not receive any response from the hSMF due to communication failure on the N16 interface, depending on operator policy the V-SMF may create the PDU Session to one of the alternative hSMF(s) 125 if additional hSMF information is provided in step 3a.

The IE V-CN-Tunnel-Info is in an embodiment of type TunnelInfo. In an embodiment, this IE contains at least the GTP-U tunnel information for downlink traffic towards the vUPF. It might contain additional info e.g. time stamp.

In step 13, the hSMF 125 responds with a Create Response, in which it includes the IE H-CN-Tunnel Info.

13. hSMF 125 to vSMF 115: Nsmf PDUSession_Create Response (QoS Rule(s), QoS Flow level QoS parameters if needed for the QoS Flow(s) associated with the QoS rule(s), PCO including session level information that the vSMF 115 is not expected to understand, selected PDU Session Type and SSC mode, H-CN Tunnel Info, QFI(s), QoS profile(s), Session-AMBR, Reflective QoS Timer (if available), information needed by the vSMF 115 in case of EPS interworking such as the PDN Connection Type, User Plane Policy Enforcement)

The H-CN-Tunnel Info, of type TunnelInfo, contains the GTP-U tunnel information for uplink traffic towards the hUPF 123.

The TunnelInfo will be further described in the following, in part d).

In an embodiment, the Nsmf PDUSession service operates on PDU Sessions. In an example embodiment, the service operations exposed by this service allow other network functions, NF (e.g. AMF or a peer SMF) to establish, modify and release the PDU Sessions.

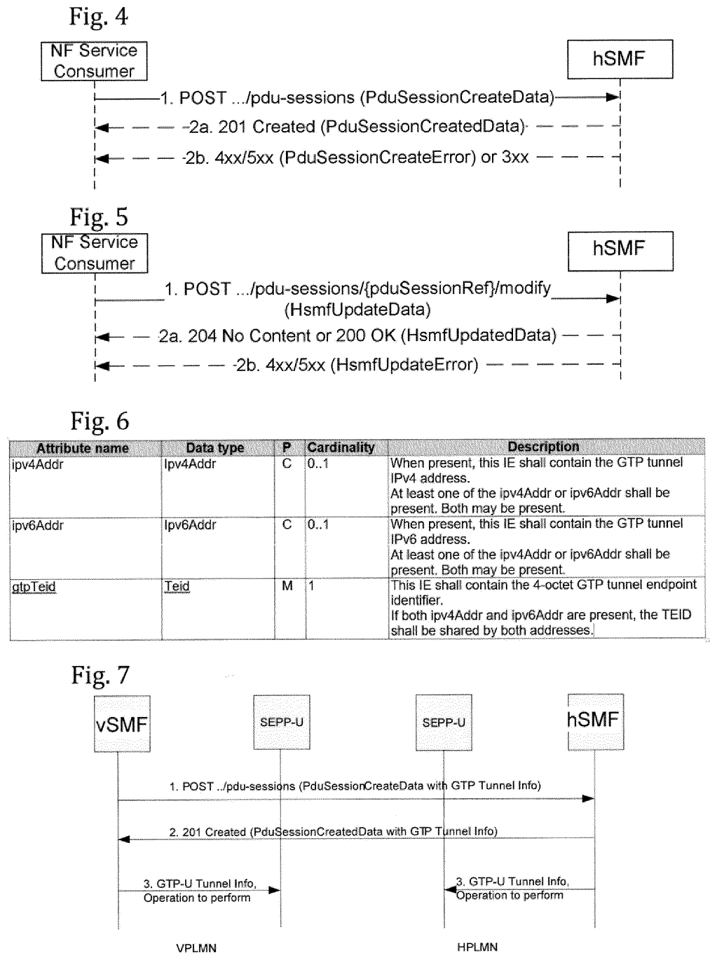

FIG. 4 shows a call flow that depicts PDU session creation request by an NF Service Consumer (vSMF 115).

In step 1, the vSMF 115 sends a POST request to the hSMF 125. The payload body of the POST request contains an attribute vcnTunnelInfo, which includes the N9 tunnel information on the visited core network, CN, side. This information comprises GTP tunnel IP address and Tunnel endpoint identifier, TEID, that will be used by the hSMF 125 to send downlink traffic towards the vSMF 115.

In step 2a, “201 Created” is returned by the hSMF 125 with the payload body of the POST response containing contains a new attribute hcnTunnelInfo, which includes the N9 tunnel information on the home Core Network (CN) side. This information comprises GTP tunnel IP address and Tunnel endpoint identifier (TEID) that will be used by the vSMF 115 to send uplink traffic towards the hSMF 125

b) Update PDU Session Service Operation

FIG. 5 shows a scenario where the Update service operation is used by the vSMF 115 to update an individual PDU session in the hSMF 125, e.g. to change the vcnTunnelInfo when a new vUPF 115 is reselected in the VPLMN 110.

In step 1, the vSMF 115 sends a POST request with the payload of the POST request containing the vcnTunnelInfo attribute. This attribute shall be present if the N9 tunnel information on the visited CN side provided earlier to the H-SMF 125 has changed. When present, this IE shall contain the new N9 tunnel information on the visited CN side.

c) EPS to 5GS Idle Mode or Connected Mode Mobility

EPS to 5GS idle mode or connected mode using N26 mobility reuses the SMF PDUSession Create SM Context and Create service operations. Hence, the same call flow as in FIG. 4 applies.

d) Definition of Type TunnelInfo

FIG. 6 shows an example of the TunnelInfo definition.

In an embodiment, a GTP-U tunnel is identified by an IP address (v4 or v6) and the TEID.

SEPP-U 114 is next further described. In an example embodiment, the SEPP-U 114 is or comprises a GTP-U firewall for the N9 interface. The SEPP-U 114 filters GTP-U messages in a way that only genuine GTP-U packets over the N9 interface that correspond to PDU sessions established through the N32 interface can transit through the firewall. All other GTP-U packets are discarded and optionally logged. This helps to avoid that unwanted GTP-U packets enter or leave the core network.

In an embodiment, the GTP-U packet consists of the original payload encapsulated by three headers: GTP, UDP, and IP.
In the uplink direction, the IP header contains a vUPF 113 IP address as a source address and an hUPF 123 IP address as a destination address.
In the downlink direction, the IP header contains an hUPF 123 IP address as a source address and a vUPF 113 IP address as a destination address.
The TEID which is present in the GTP-U header indicates which tunnel a particular GTP payload belongs to.
The GTP-U tunnel is identified by the GTP-U TEID and the IP address (destination TEID, destination IP address).

In an example embodiment, the SEPP-U function is deployed at the edge of the operator network to monitor incoming GTP-U traffic on the N9 interface, or the outgoing GTP-U traffic on the N9 interface or both.

In an embodiment, the SEPP-U function is inside the UPF, and executes GTP-U checks for every incoming GTP-U packet on the N9 interface.

The following list describes the types of GTP-U inspections that may be performed on the incoming traffic by SEPP-U:

a) GTP-U tunnel check: The SEPP-U function checks that the destination IP address and the TEID in the GTP-U packet belongs to an active PDU session. The GTP-U packet is dropped otherwise.

b) Source address check in the IP header: The SEPP-U checks whether the source IP Address in the outer IP header belongs to a valid PDU session by checking it with the available TunnelInfo information it has in its local store, and this TEID matches the TEID found in the GTP header of the received GTP-U packet. If this check fails, the GTP-U packet is dropped.

NOTE: source address checking may be optional and based on Service Level Agreements between the roaming partners.

A new interface is proposed between the SEPP-U and a Core Network control plane entity for some embodiments. This new interface can be used for communication between the core network control plane entity and SEPP-U.

In an embodiment, the Core Network control plane entity is:

a) the SMF, which has access to the TunnelInfo information of both endpoints, or

b) the SEPP at the perimeter of the network that obtains TunnelInfo information by intercepting specific HTTP POST messages between vSMF and hSMF (all inter-PLMN signaling goes through the SEPPs and N32 interface).

FIG. 7 illustrates major signaling on the new interface between the SEPP-U and the SMF that is in FIG. 7 the control plane entity that supplies the SEPP-U with the remote GTP-U tunnel information including the TEID and the IP address.

In an embodiment in which the SEPP is used as the core network control plane entity, the SEPP learns about the valid TEIDs and tunnel IP address information by intercepting SMF to SMF signaling on the N16 interface going over the SEPP to SEPP N32 interface. The SEPP looks for the following information on the N16 interface:

a) GTP-U tunnel IP address and TEID of the local N9 endpoint, i.e. within its own network; and

b) GTP-U tunnel IP address and TEID of the remote N9 endpoint, i.e. in the other network.

In an example embodiment, the, CN control plane entity pushes the local TunnelInfo information of the GTP-U tunnel endpoint in its network and optionally the peer network TunnelInfo information of the peer GTP-U tunnel endpoint obtained from the other network to SEPP-U during each procedure discussed in part a) background section of this invention. This allows the SEPP-U to identify and verify whether the incoming GTP-U traffic targets a valid GTP-U end point in the network receiving the GTP-U packet and/or that it is from a valid network or not. In addition, the CN control plane entity also indicates which operation to perform in the SEPP-U for the TunnelInfo information (i.e. add, modify or remove valid GTP-U information in the SEPP-U, request to only check target destination IP address and TEI, or also check source IP address of the GTP-U packet).

In an example embodiment, the SEPP-U receives GTP Tunnel Info from SEPP or SMF and executes the required operations.

In an example embodiment, the protocol between the CN control plane entity and the SEPP-U is based on the existing N4 interface and Packet Forwarding Control Protocol, PFCP. In an example embodiment, the protocol between the CN control plane entity and the SEPP-U is a different protocol, such as an HTTP API.

In some embodiments in which the SEPP-U is in, or co-located with the UPF, the existing N4 interface and the PFCP between the SMF and the UPF is used by the SMF to push the GTP-U TunnelInfo to the UPF.

When implementing the interface based on the PFCP protocol, the core network control plane protocol may provision one or more PFCP sessions in the SEPP-U (or the UPF) with Packet Detection Rules, PDRs, that match the allowed GTP-U traffic and corresponding Forwarding Action Rules, FARs, set to pass on the traffic.

Packet Detection Information, PDI, in the PDR can be set e.g. using the following parameters shown in table I below:

TABLE I
Example PDI

| | | PDI IE Type = 2 (decimal) | | | | | |
|---|---|---|---|---|---|---|---|
| | | Length = n | | | | | |
| Octet 1 and 2 | | | Appl. | | | | |
| Octets 3 and 4 | | | Sx | Sx | Sx | | |
| Information elements | P | Condition/Comment | a | b | c | N4 | IE Type |
| Source Interface | M | This IE shall identify the source interface of the incoming | X | X | X | X | Source Interface |
| | | packet. | | | | | |
| Local F-TEID | O | This IE shall not be present if Traffic Endpoint ID is present. | X | X | — | X | F-TEID |
| | | If present, this IE shall identify the local F-TEID to match | | | | | |
| | | for an incoming packet. | | | | | |
| Network Instance | O | This IE shall not be present if Traffic Endpoint ID is present. | X | X | X | X | Network Instance |
| | | If present, this IE shall identify the Network instance to | | | | | |
| | | match for the incoming packet. See NOTE 1, NOTE 2. | | | | | |
| Traffic Endpoint ID | C | This IE may be present if the UP function has indicated | X | X | X | X | Traffic Endpoint |
| | | the support of PDI optimization. | | | | | ID |
| | | If present, this IE shall uniquely identify the Traffic | | | | | |
| | | Endpoint for that PFCP session. | | | | | |
| SDF Filter | O | If present, this IE shall identify the SDF filter to match for | — | X | X | X | SDF Filter |
| | | the incoming packet. Several IEs with the same IE type | | | | | |
| | | may be present to provision a list of SDF Filters. The full | | | | | |
| | | set of applicable SDF filters, if any, shall be provided | | | | | |
| | | during the creation or the modification of the PDI. See NOTE 3. | | | | | |

In another example embodiment, the PDI is set as a Traffic Endpoint ID as shown below in table II, representing the local IP address and TEID of the GTP-U tunnel in the network receiving the GTP-U traffic.

TABLE II
Creating Traffic Endpoint IE within PFCP Session Establishment Request

| | | Create Traffic Endpoint IE Type = 127(decimal) | | | | | |
|---|---|---|---|---|---|---|---|
| | | Length = n | | | | | |
| Octet 1 and 2 | | | Appl. | | | | |
| Octets 3 and 4 | | | Sx | Sx | Sx | | |
| Information elements | P | Condition/Comment | a | b | c | N4 | IE Type |
| Traffic Endpoint ID | M | This IE shall uniquely identify the Traffic Endpoint for that | X | X | X | X | Traffic Endpoint ID |
| | | Sx session. | | | | | |
| Local F-TEID | O | If present, this IE shall identify the local F-TEID to match | X | X | — | X | F-TEID |
| | | for an incoming packet. The CP function shall set the | | | | | |
| | | CHOOSE (CH) bit to 1 if the UP function supports | | | | | |
| | | the allocation of F-TEID and the CP | | | | | |
| | | function requests the UP function to assign a local F-TEID | | | | | |
| | | to the Traffic Endpoint. | | | | | |
| Network Instance | O | If present, this IE shall identify the Network instance to | X | X | X | X | Network Instance |
| | | match for the incoming packet. See NOTE 1, NOTE 2. | | | | | |

Interface Between UPFs and SEPP-U

In some example embodiments where the SEPP-U function is centralized, for e.g. sitting at the perimeter configured to perform GTP-U firewall function on a traffic destined to a set of UPFs, the SEPP-U is set up as

a) an intercepting or a transparent proxy or

b) a non-transparent proxy with a secure interface with the UPF.

When the SEPP-U is set up as an intercepting proxy at the edge of the network,

a) the SEPP-U may intercept all incoming GTP-U traffic on the N9 interface, perform required sanity checks, and forward valid GTP-U traffic to the concerned UPF inside the network for further processing. This helps in enforcing that only valid GTP-U traffic is received at the UPF.

b) the SEPP-U may intercept all outgoing GTP-U traffic from UPFs, perform the required sanity checks, and forward valid GTP-U traffic towards the other network.

By functioning as an intercepting proxy, the SEPP-U function looks for a specific pattern in the GTP-U packet (basically the GTP header and the IP address in the IP Header) for the validity checks. The UPFs may not be aware that the SEPP-U exists at the perimeter of the network to monitor the incoming GTP-U traffic.

When the SEPP-U is set up at the edge of the network as a GTP-aware non-transparent proxy, the UPFs may transmit and receive GTP-U packets via the SEPP-U. In the outbound direction (egress), the UPFs can be configured to transmit GTP-U packets to SEPP-U. In the inbound direction (ingress), the SEPP-U receives the GTP-U traffic from the N9 interface, and forwards legitimate GTP-U traffic to target UPFs.

In an example embodiment, the SEPP-U is implemented and deployed as a pool of SEPP-Us, sharing the same set of data (valid GTP-U tunnel information received from core network control plane entity) e.g. via a shared Data Storage Function.

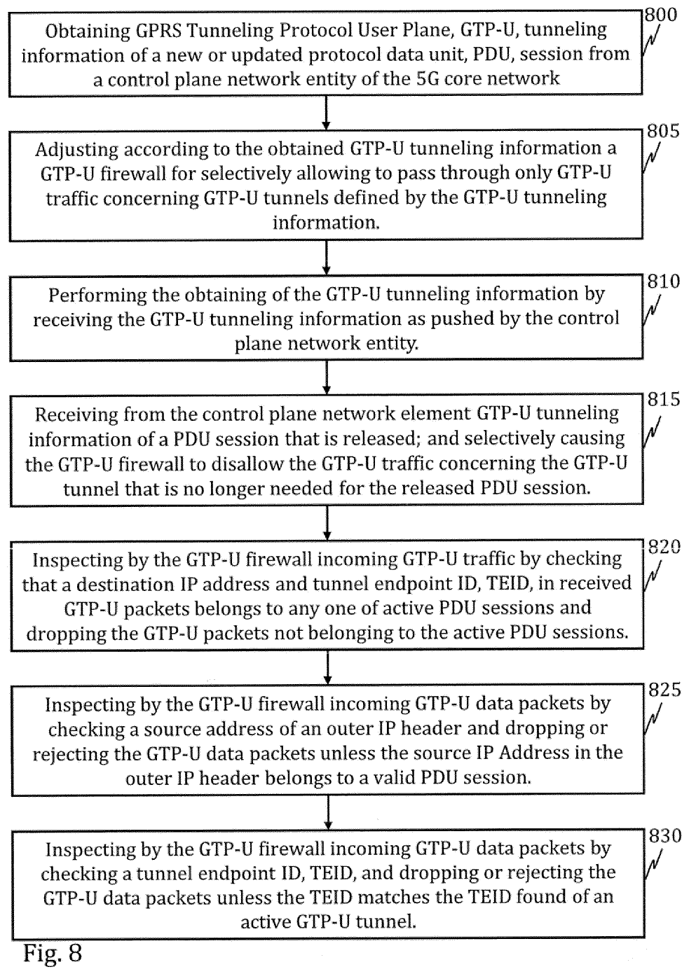

FIG. 8 shows a flow chart of a method in a user plane network entity of a 5G core network, comprising:

800. Obtaining GPRS Tunneling Protocol User Plane, GTP-U, tunneling information of a new or updated protocol data unit, PDU, session from a control plane network entity of the 5G core network.

805. Adjusting according to the obtained GTP-U tunneling information a GTP-U firewall for selectively allowing to pass through only GTP-U traffic concerning GTP-U tunnels defined by the GTP-U tunneling information.

810. Performing the obtaining of the GTP-U tunneling information by receiving the GTP-U tunneling information as pushed by the control plane network entity.

815. Receiving from the control plane network element GTP-U tunneling information of a PDU session that is released; and selectively causing the GTP-U firewall to disallow the GTP-U traffic concerning the GTP-U tunnel that is no longer needed for the released PDU session.

820. Inspecting by the GTP-U firewall incoming GTP-U traffic by checking that a destination IP address and tunnel endpoint ID, TEID, in received GTP-U packets belongs to any one of active PDU sessions and dropping the GTP-U packets not belonging to the active PDU sessions.

825. Inspecting by the GTP-U firewall incoming GTP-U data packets by checking a source address of an outer IP header and dropping or rejecting the GTP-U data packets unless the source IP Address in the outer IP header belongs to a valid PDU session.

830. Inspecting by the GTP-U firewall incoming GTP-U data packets by checking a tunnel endpoint ID, TEID, and dropping or rejecting the GTP-U data packets unless the TEID matches the TEID found of an active GTP-U tunnel.

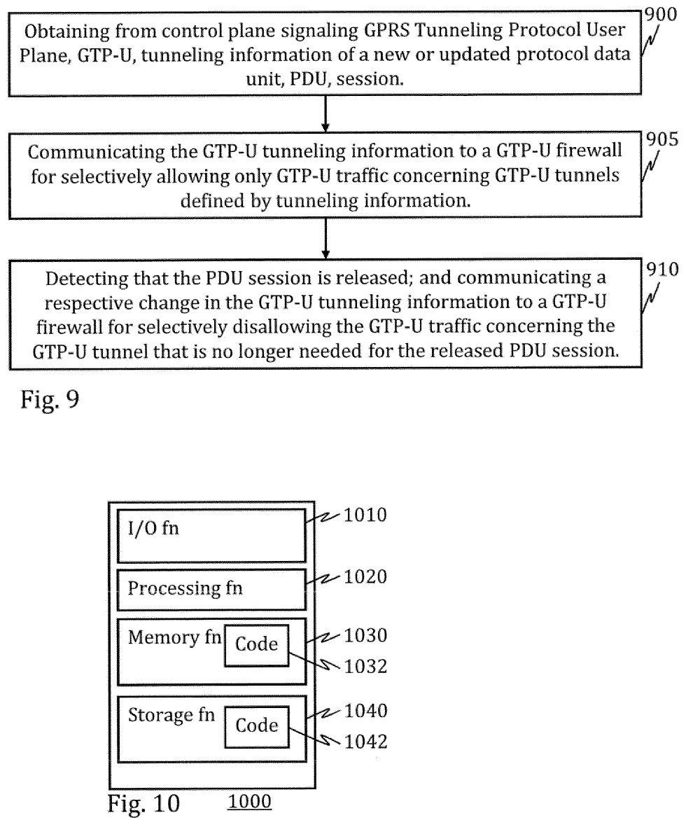

FIG. 9 shows a flow chart of a method in a control plane network entity of a 5G core network, comprising:

900. Obtaining from control plane signaling GPRS Tunneling Protocol User Plane, GTP-U, tunneling information of a new or updated protocol data unit, PDU, session.

910. Communicating the GTP-U tunneling information to a GTP-U firewall for selectively allowing only GTP-U traffic concerning GTP-U tunnels defined by tunneling information.

915. Detecting that the PDU session is released; and communicating a respective change in the GTP-U tunneling information to a GTP-U firewall for selectively disallowing the GTP-U traffic concerning the GTP-U tunnel that is no longer needed for the released PDU session.

FIG. 10 shows a simplified block diagram of an apparatus 1000 according to an embodiment for implementing various network functions such as the SMF 115, the SEPP 117, the UPF or the SEPP-U. The apparatus 1000 is drawn and described as a computer cloud implementation and it should be appreciated that one or more parts could in other implementations use dedicated elements, whether singular or distributed or virtualized.

The apparatus 1000 comprises an input/output function 1010. The input/output function 1010 may comprise one or more communication circuitries, virtualized functions and/or cloud computing functions, configured to input and output data. The input and output functions may be commonly or separately implemented.

The apparatus 1000 further comprises a processing function 1020, which may comprise one or more processors, processing circuitries, virtualized functions and/or cloud computing functions. The processing function 1020 is responsible for controlling the at least such operations of the apparatus 1000 that are relevant for some embodiments of this document, while some other operations of the apparatus 1000 can be controlled by further circuitries.

The apparatus 1000 further comprises a memory function 1030, which can be provided with computer program code 1032, e.g., on starting of the apparatus 1000 and/or during the operation of the apparatus 1000. The program code 1032 may comprise applications, one or more operating systems, device drivers, code library files, device drivers and other computer executable instructions. The memory function 1030 can be implemented using one or more memory circuitries, virtual resources of a virtualization environment and/or cloud computing resources.

The apparatus 1000 further comprises a storage function 1040, which can be provided with computer program code 1042 and other data to be stored. Some or all of the program code 1042 may be transferred to the memory function 1030 from the storage function 1040. The storage function 1040 can be implemented using one or more storage circuitries, hard drives, optical storages, magnetic storages, virtual resources of a virtualization environment and/or cloud computing resources.

In this description, distinction has been made where appropriate between visited and home network functions using respective prefixes v an h, but in many occasions, reference has been made simply to the function as such without the prefix intending to cover both roles as home and visited function.

It should also be appreciated that often if not always, the network functions simultaneously operate in both visited and home network roles for different data flows.

As used in this application, the term “circuitry” may refer to one or more or all of the following:

(a) hardware-only circuit implementations (such as implementations in only analog and/or digital circuitry) and;

(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions); and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Without in any way limiting the scope, interpretation, or application of the claims appearing below, a technical effect of one or more of the example embodiments disclosed herein is that GTP-U attacks against a PLMN core network may be hindered.

Embodiments may be implemented in software, hardware, application logic or a combination of software, hardware and application logic. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a computer described and depicted in FIG. 10. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the before-described functions may be optional or may be combined.

Although various aspects are set out in the independent claims, other aspects comprise other combinations of features from the described embodiments and/or the dependent claims with the features of the independent claims, and not solely the combinations explicitly set out in the claims.

It is also noted herein that while the foregoing describes example embodiments, these descriptions should not be viewed in a limiting sense. Rather, there are several variations and modifications which may be made without departing from the scope defined in the appended claims.

1-18. (canceled)

19. A user plane network entity of a 5G core network, comprising at least one processor; and at least one memory including computer program code; the at least one memory and the computer program code configured to, with the at least one processor, cause the user plane network entity at least to:
obtain GPRS Tunneling Protocol User Plane, GTP-U, tunneling information of a new or updated protocol data unit, PDU, session from a control plane network entity of the 5G core network; and
adjust according to the obtained GTP-U tunneling information a GTP-U firewall for selectively allowing to pass through only GTP-U traffic concerning GTP-U tunnels defined by the GTP-U tunneling information.

20. The user plane network entity according to claim 19, wherein the GTP-U tunneling information is obtained by receiving the GTP-U tunneling information as pushed by the control plane network entity.

21. The user plane network entity according to claim 19, further configured to:
receive from the control plane network element GTP-U tunneling information of a PDU session that is released; and
selectively cause the GTP-U firewall to disallow passing through the GTP-U traffic concerning the GTP-U tunnel that is no longer needed for the released PDU session.

22. The user plane network entity according to claim 19, wherein the user plane network entity is a Security Edge Protection Proxy, SEPP, for user plane traffic, SEPP-U.

23. The user plane network entity according to claim 19, wherein:
the user plane network entity is a distributed entity comprising a plurality of units; and
units have access to tunneling information stored in a storage shared jointly accessible by the pool.

24. The user plane network entity according to claim 19, wherein the user plane network entity monitors GTP-U traffic incoming to the 5G core network.

25. The user plane network entity according to claim 19, wherein the user plane network entity is collocated with a 5G user plane function, UPF.

26. The user plane network entity according to claim 19, further configured to inspect incoming GTP-U traffic by checking that a destination IP address and tunnel endpoint ID, TEID, in received GTP-U packets belongs to any one of active PDU sessions and to drop the GTP-U packets not belonging to the active PDU sessions.

27. The user plane network entity according to claim 19, further configured to inspect incoming GTP-U data packets by checking a source address of an outer IP header and drop or reject the GTP-U data packets unless the source IP address in the outer IP header belongs to a valid PDU session.

28. A control plane network entity of a 5G core network, comprising at least one processor; and at least one memory including computer program code; the at least one memory and the computer program code configured to, with the at least one processor, cause the control plane network entity at least to:
obtain from control plane signaling GPRS Tunneling Protocol User Plane, GTP-U, tunneling information of a new or updated protocol data unit, PDU, session; and
communicate the GTP-U tunneling information to a GTP-U firewall for selectively allowing to pass through only GTP-U traffic concerning GTP-U tunnels defined by tunneling information.

29. The control plane network entity according to claim 28 further configured to:
detect that the PDU session is released; and
communicate a respective change in the GTP-U tunneling information to a GTP-U firewall for selectively disallowing to pass through the GTP-U traffic concerning the GTP-U tunnel that is no longer needed for the released PDU session.

30. The control plane network entity according to claim 28, wherein the control plane network entity is a Session Management Function, SMF, or is collocated with a SMF.

31. The control plane network entity according to claim 28, wherein the control plane network entity is configured to communicate with the user plane network entity over an N4 interface.

32. The control plane network entity according to claim 28, wherein the control plane network entity is a Security Edge Protection Proxy, SEPP.

33. The control plane network entity according to claim 32, wherein the control plane network entity is configured to detect the GTP-U tunneling information by intercepting passing-through PDU session establishment, modification and release messaging.

34. A method in a user plane network entity of a 5G core network, comprising:
obtaining GPRS Tunneling Protocol User Plane, GTP-U, tunneling information of a new or updated protocol data unit, PDU, session from a control plane network entity of the 5G core network; and
adjusting according to the obtained GTP-U tunneling information a GTP-U firewall for selectively allowing to pass through only GTP-U traffic concerning GTP-U tunnels defined by the GTP-U tunneling information.

35. The method according to claim 34, wherein the GTP-U tunneling information is obtained by receiving the GTP-U tunneling information as pushed by the control plane network entity.

36. The method according to claim 34, further comprising:
receiving from the control plane network element GTP-U tunneling information of a PDU session that is released; and
selectively causing the GTP-U firewall to disallow passing through the GTP-U traffic concerning the GTP-U tunnel that is no longer needed for the released PDU session.

37. A method in a control plane network entity of a 5G core network, comprising:
obtaining from control plane signaling GPRS Tunneling Protocol User Plane, GTP-U, tunneling information of a new or updated protocol data unit, PDU, session; and
communicating the GTP-U tunneling information to a GTP-U firewall for selectively allowing to pass through only GTP-U traffic concerning GTP-U tunnels defined by tunneling information.

38. The method according to claim 37, further comprising:
detecting that the PDU session is released; and
communicating a respective change in the GTP-U tunneling information to a GTP-U firewall for selectively disallowing to pass through the GTP-U traffic concerning the GTP-U tunnel that is no longer needed for the released PDU session.
